(19) United States
(12) Patent Application Publication
(10) Pub. No.: US 2026/0140137 A1
(43) Pub. Date: May 21, 2026

(54) DEVICE AND METHOD FOR FUSING DATA FROM TWO ACCELEROMETERS HAVING DIFFERENT OPERATING RANGES

(71) Applicant: STMicroelectronics International N.V., Geneva (CH)

(72) Inventors: Swapnil Sayan SAHA, Mountain View, CA (US); Sneha SHAHI, San Jose, CA (US); Siddharth SIDDHARTH, Mountain View, CA (US); Krishna Chaitanya PALLE HAYAGREEVA, Vancouver (CA); Mahesh CHOWDHARY, San Jose, CA (US)

(21) Appl. No.: 18/955,316

(22) Filed: Nov. 21, 2024

(51) Int. Cl. G01P 15/00

(52) U.S. Cl. CPC G01P 15/18; G01P 21/00

(57) ABSTRACT

In accordance with various embodiments of the present disclosure, a method for fusing data between a first accelerometer having a first operating range and a second accelerometer having a second operating range greater than the first operating range is provided. In some embodiments, the method comprises determining (i) if an acceleration of any axis of the first accelerometer is between a first threshold and a negative of the first threshold or (ii) if an acceleration of any axis of the second accelerometer is greater than a second threshold or less than a negative of the second threshold, or (iii) if an acceleration of any axis of the first accelerometer is greater than the first threshold or less than the negative of the first threshold or if an acceleration of any axis of the second accelerometer is between the second threshold and the negative of the second threshold.

### FIELD OF THE INVENTION

Example embodiments of the present disclosure relate generally to accelerometers and, more particularly, devices that use both a low-g and a high-g accelerometer.

### BACKGROUND

Many mobile devices, such as mobile phones and smart watches, have a built-in accelerometer. For example, in smart watches such accelerometers are often used for velocity and high-intensity motion analysis in sports medicine (e.g., handball, baseball, tennis, and golf), fall detection, physiological tracking, and wrist movement analysis in gaming and virtual reality control. Some accelerometers (termed “low-g”) are able to detect acceleration across a low range—typically across a range of about +/−16 g—but have a high resolution. Some accelerometers (termed “high-g”) are able to detect acceleration across a wider range—typically across a range of about +/−256 g—but have a relatively poor resolution. This is seen in FIG. 2A, in which the coarseness of the high-g data (thinner line) indicates its much lower resolution as compared to the smoother low-g data (thicker line). With a low-g accelerometer, acceleration outside of its operating range (e.g., above 16 g or below −16 g) will saturate the accelerometer.

To provide acceleration detection across a wide range, it may be desirable to use both a low-g and a high-g accelerometer. However, fusing the data from both a low-g and a high-g accelerometer is difficult due to offsets and discontinuity between the data from the two types of devices, and due to the high noise of the high-g accelerometer. Also, it would be undesirable to keep both accelerometers powered on at all times as that would cause unnecessarily high power consumption. In FIG. 2A, the time-varying offset between the high-g data (thinner line) and the low-g data (thicker line) is readily seen. In FIG. 3A, the discontinuity between the high-g data (thinner line) and the low-g data (thicker line) (i.e., the gap between the two lines) is readily seen. This discontinuity is due to different response characteristics of the two sensors.

Applicant has identified many technical challenges and difficulties associated with using two accelerometers with different operating ranges in a device. Through applied effort, ingenuity, and innovation, Applicant has solved problems related to using two accelerometers with different operating ranges in a device by developing solutions embodied in the present disclosure, which are described in detail below.

### BRIEF SUMMARY

Various embodiments described herein relate to devices and methods for fusing data between a first accelerometer having a first operating range and a second accelerometer having a second operating range greater than the first operating range. Various embodiments described herein also relate to devices and methods for generating interrupt signals related to output data from two accelerometers having different operating ranges.

In accordance with various embodiments of the present disclosure, a method for fusing data between a first accelerometer having a first operating range and a second accelerometer having a second operating range greater than the first operating range is provided. In some embodiments, the method comprises determining (i) if an acceleration of any axis of the first accelerometer is between a first threshold and a negative of the first threshold or (ii) if an acceleration of any axis of the second accelerometer is greater than a second threshold or less than a negative of the second threshold, the second threshold being greater than the first threshold, or (iii) if an acceleration of any axis of the first accelerometer is greater than the first threshold or less than the negative of the first threshold or if an acceleration of any axis of the second accelerometer is between the second threshold and the negative of the second threshold; when the acceleration of any axis of the first accelerometer is between the first threshold and the negative of the first threshold, (i) receiving data from only the first accelerometer and (ii) outputting the data received from the first accelerometer without further processing; when the acceleration of any axis of the second accelerometer is greater than the second threshold or less than the negative of the second threshold, (i) receiving data from only the second accelerometer, (ii) performing offset compensation on the data received from the second accelerometer to compensate for an offset between data from the second accelerometer and data from the first accelerometer, and (iii) outputting the offset compensated data from the second accelerometer; and when the acceleration of any axis of the first accelerometer is greater than the first threshold or less than the negative of the first threshold or the acceleration of any axis of the second accelerometer is between the second threshold and the negative of the second threshold, (i) receiving data from both the first accelerometer and the second accelerometer; (ii) performing time-varying offset compensation on the data received from the second accelerometer to compensate for a time-varying offset between data from the second accelerometer and data from the first accelerometer, (iii) fusing the data from the first accelerometer and the time-varying offset compensated data from the second accelerometer between the first threshold and the second threshold, and (iii) outputting the fused data.

In some embodiments, determining if an acceleration of any axis of the first accelerometer is between a first threshold and a negative of the first threshold comprises receiving a second interrupt signal indicating that the acceleration of any axis of the first accelerometer has gone from above the first threshold to below the first threshold or has gone from below the negative of the first threshold to above the negative of the first threshold: determining if an acceleration of any axis of the second accelerometer is greater than a second threshold or less than a negative of the second threshold comprises receiving a fourth interrupt signal indicating that the acceleration of any axis of the second accelerometer has gone from below the second threshold to above the second threshold or has gone from above the negative of the second threshold to below the negative of the second threshold; determining if an acceleration of any axis of the first accelerometer is greater than the first threshold or less than the negative of the first threshold comprises receiving a first interrupt indicating that the acceleration of any axis of the first accelerometer has gone from below the first threshold to above the first threshold or has gone from above the negative of the first threshold to below the negative of the first threshold; and determining if an acceleration of any axis of the second accelerometer is between the second threshold and the negative of the second threshold comprises receiving a third interrupt indicating that the acceleration of any axis of the second accelerometer has gone from above the second threshold to below the second threshold or has gone from below the negative of the second threshold to above the negative of the second threshold.

In some embodiments, the method further comprises activating the first accelerometer when the second interrupt signal is received; activating the second accelerometer when the fourth interrupt signal is received; and activating the first accelerometer and the second accelerometer when the first interrupt signal is received or when the third interrupt signal is received.

In some embodiments, performing offset compensation on the data received from the second accelerometer comprises subtracting a most recent offset value from each point of data received from the second accelerometer.

In some embodiments, the most recent offset value comprises a difference between an average of data from the second accelerometer and an average of data from the first accelerometer during a startup test.

In some embodiments, the most recent offset value comprises a most recently calculated difference between a running average of data from the second accelerometer and a running average of data from the first accelerometer.

In some embodiments, performing time-varying offset compensation on the data received from the second accelerometer comprises subtracting from each point of data received from the second accelerometer a difference between a running average of data from the second accelerometer and a running average of data from the first accelerometer.

In some embodiments, fusing the data from the first accelerometer and the time-varying offset compensated data from the second accelerometer comprises blending, from the first threshold to the second threshold, the data from the first accelerometer and the data from the second accelerometers such that the blended data coincides with the data from the first accelerometer at the first threshold and coincides with the data from the second accelerometer at the second threshold.

In some embodiments, when the acceleration of any axis of the second accelerometer is greater than the second threshold or less than the negative of the second threshold, the method further comprises, after performing offset compensation on the data received from the second accelerometer and before outputting the offset compensated data from the second accelerometer, removing noise from the compensated data.

In some embodiments, when the acceleration of any axis of the first accelerometer is greater than the first threshold or less than the negative of the first threshold or the acceleration of any axis of the second accelerometer is between the second threshold and the negative of the second threshold, the method further comprises, after performing time-varying offset compensation on the data received from the second accelerometer and before fusing the data from the first accelerometer and the time-varying offset compensated data, removing noise from the time-varying offset compensated data.

In some embodiments, the second threshold is an upper operating limit of the first accelerometer.

In some embodiments, the first operating range of the first accelerometer is =/−16 g the second operating range of the second accelerometer is =/−256 g.

In some embodiments, the first threshold is 13 g and the second threshold is 16 g.

In accordance with various embodiments of the present disclosure, a semiconductor system-in-package device for generating interrupt signals related to output data from two accelerometers having different operating ranges is provided. In some embodiments, the device comprises a first accelerometer having a first operating range; a second accelerometer having a second operating range greater than the first operating range; and circuitry for implementing a finite state machine configured to: monitor output data from the first accelerometer and output data from the second accelerometer; and output one of a plurality of interrupt signals based on the output data from the first accelerometer and/or the output data from the second accelerometer.

In some embodiments, the circuitry for implementing a finite state machine is further configured to determine if an acceleration of any axis of the first accelerometer has gone from above a first threshold to below the first threshold or has gone from below a negative of the first threshold to above the negative of the first threshold: determine if an acceleration of any axis of the second accelerometer has gone from below a second threshold to above the second threshold or has gone from above a negative of the second threshold to below the negative of the second threshold, the second threshold being greater than the first threshold; determine if an acceleration of any axis of the first accelerometer has gone from below the first threshold to above the first threshold or has gone from above the negative of the first threshold to below the negative of the first threshold; determine if an acceleration of any axis of the second accelerometer has gone from above the second threshold to below the second threshold or has gone from below the negative of the second threshold to above the negative of the second threshold; if an acceleration of any axis of the first accelerometer has gone from above the first threshold to below the first threshold or has gone from below the negative of the first threshold to above the negative of the first threshold, output a second interrupt signal; if an acceleration of any axis of the second accelerometer has gone from below the second threshold to above the second threshold or has gone from above the negative of the second threshold to below the negative of the second threshold, output a fourth interrupt signal; if an acceleration of any axis of the first accelerometer has gone from below the first threshold to above the first threshold or has gone from above the negative of the first threshold to below the negative of the first threshold, output a first interrupt signal; and if an acceleration of any axis of the second accelerometer has gone from above the second threshold to below the second threshold or has gone from below the negative of the second threshold to above the negative of the second threshold, output a third interrupt signal.

In accordance with various embodiments of the present disclosure, a method for generating interrupt signals related to output data from a first accelerometer having a first operating range and output data from a second accelerometer having a second operating range greater than the first operating range is provided. In some embodiments, the method comprises monitoring output data from the first accelerometer and output data from the second accelerometer; determining if an acceleration of any axis of the first accelerometer has gone from above a first threshold to below the first threshold or has gone from below a negative of the first threshold to above the negative of the first threshold: determining if an acceleration of any axis of the second accelerometer has gone from below a second threshold to above the second threshold or has gone from above a negative of the second threshold to below the negative of the second threshold, the second threshold being greater than the first threshold; determining if an acceleration of any axis of the first accelerometer has gone from below the first threshold to above the first threshold or has gone from above the negative of the first threshold to below the negative of the first threshold; determining if an acceleration of any axis of the second accelerometer has gone from above the second threshold to below the second threshold or has gone from below the negative of the second threshold to above the negative of the second threshold; if an acceleration of any axis of the first accelerometer has gone from above the first threshold to below the first threshold or has gone from below the negative of the first threshold to above the negative of the first threshold, outputting a second interrupt signal; if an acceleration of any axis of the second accelerometer has gone from below the second threshold to above the second threshold or has gone from above the negative of the second threshold to below the negative of the second threshold, outputting a fourth interrupt signal; if an acceleration of any axis of the first accelerometer has gone from below the first threshold to above the first threshold or has gone from above the negative of the first threshold to below the negative of the first threshold, outputting a first interrupt signal; and if an acceleration of any axis of the second accelerometer has gone from above the second threshold to below the second threshold or has gone from below the negative of the second threshold to above the negative of the second threshold, outputting a third interrupt signal.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a block diagram of an example system for fusing data between two accelerometers having different operating ranges, in accordance with some embodiments of the present disclosure;

FIGS. 2A and 2B illustrate example data from a low-g accelerometer and a high-g accelerometer, respectively, before and after performing offset compensation on the data, in accordance with some embodiments of the present disclosure;

FIGS. 3A and 3B illustrate example data from a low-g accelerometer and a high-g accelerometer, respectively, before and after fusing the data, in accordance with some embodiments of the present disclosure; and

FIG. 4 provides an example flow diagram illustrating an example method fusing data between two accelerometers having different operating ranges, in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing example systems and methods for fusing data between two accelerometers having different operating ranges. Various embodiments of the present disclosure may be implemented in any suitable device having two such accelerometers, including but not limited to mobile phones or smart watches. Such accelerometers are also termed sensors herein. As described herein, the two accelerometers will be termed a low-g accelerometer and a high-g accelerometer. The terms are relative and refer to accelerometers having different operating ranges (one greater than the other). The data from the two accelerometers have a time-varying offset and a discontinuity, and the data from the accelerometer with the greater operating range are typically noisier than the data from the other accelerometer. As described herein, the data from the low-g accelerometer will be termed low-g data and the data from the high-g accelerometer will be termed high-g data.

In various embodiments, the high-g data is compensated for a time-varying offset, at least some of the noise is removed from the high-g data, and the data from both accelerometers is fused within a predetermined sub-range of the operating ranges to compensate for a discontinuity.

In various embodiments, a finite state machine (FSM) is resident on a semiconductor device (“chip”) that also includes a low-g accelerometer and a high-g accelerometer. In various embodiments, the FSM does not require its own microcontroller (MCU) and is not part of any MCU controlling the device itself. In various embodiments, the FSM reads the low-g and high-g sensor data (depending on which sensor is active (typically the low-g sensor is active by default)) and generates one of four interrupts (described below). In various embodiments, based on the specific interrupt generated, one or both of the accelerometers are activated (if not already activated) and the data coming from one or both accelerometers is processed as described below and then output to whatever user application (fall detection, etc.) is going to use the data.

By processing the data as described herein (including fusing the data from both accelerometers at times), embodiments of the present disclosure provide a consistent and continuous acceleration measurement over the entire dynamic range the high-g accelerometer (e.g., +/−32 g, +/−80 g, +/−256 g, +/−320 g, or higher). Embodiments of the present disclosure may be used with a low-g accelerometer having any suitable range and a high-g accelerometer having any suitable range. Embodiments of the present disclosure may be used for any suitable application, with the specific high-g accelerometer being selected based on the intended application. For example, a high-g accelerometer with a dynamic range of +/−32 g may be used for asset tracking and wearables, a high-g accelerometer with a dynamic range of +/−80 g may be used for sports activity analysis (e.g., tennis, golf, boxing, etc.), a high-g accelerometer with a dynamic range of +/−256 g may be used for car crash detection and drop detection for warranty solutions (e.g., PC, mobile phone, etc.), and a high-g accelerometer with a dynamic range of +/−320 g may be used for car crash detection. Embodiments of the present disclosure also provide the advantage of high resolution when the acceleration signal is within the operating range of the low-g accelerometer (e.g., +/−16 g) and no clipping (i.e., saturation) when acceleration is outside of the operating range of the low-g accelerometer (e.g., −16 g to −256 g and 16 g to 256 g). Embodiments of the present disclosure also use very little compute resources and run in real-time.

The accelerometer data processing (offset compensation, noise removal, data fusing) described herein is performed axis-by-axis, as needed. That is, the x-axis data is processed, the y-axis data is processed, and the z-axis data is processed.

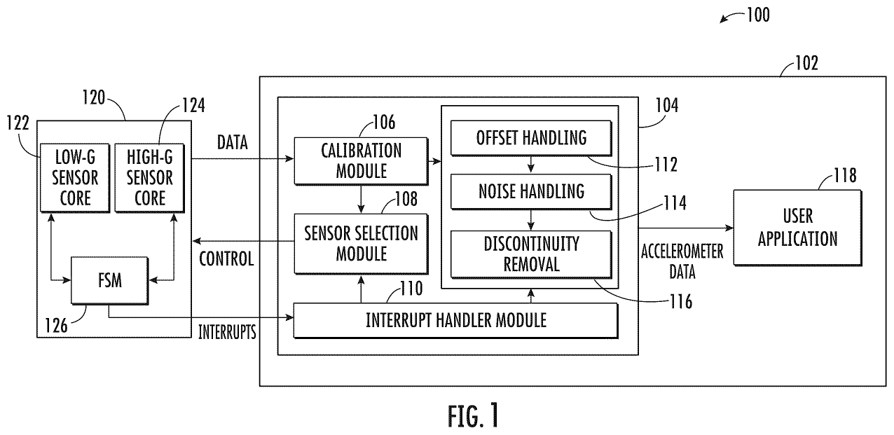

FIG. 1 illustrates a block diagram of an example system for fusing data between two accelerometers having different operating ranges, in accordance with an example embodiment of the present disclosure. The example device 100 of FIG. 1 comprises an MCU 102 and an accelerometer module 120. In various embodiments, the MCU 102 is the same MCU that controls many or most processes of the mobile device (which may be termed the main MCU). Such processes of the mobile device may include the user application 118 (e.g., fall detection) that receives and uses the accelerometer data. In various other embodiments (not illustrated), the MCU 102 is separate from and in addition to the main MCU of the mobile device. In such alternative embodiments, the user application that receives and uses the accelerometer data would likely reside on the main MCU of the mobile device instead of on the MCU 102.

The example device 100 of FIG. 1 further comprises an accelerometer handling module 104 which comprises a calibration module 106, a sensor selection module 108, an interrupt handler module 110, and a data processing module 105 which comprises an offset handling module 112, a noise handling module 114, and a discontinuity removal module 116, all of which are described further below. The accelerometer module 120 comprises a low-g accelerometer (or sensor) core 122 (e.g., having an operating range of +/−16 g), a high-g accelerometer (or sensor) core 124 (e.g., having an operating range of +/−256 g or higher), and a finite state machine (FSM) 126. In various embodiments, the accelerometer module 120 is a semiconductor device (“chip”) separate from the MCU 102. An FSM is a computational model that can be (and is in various embodiments of the disclosure) implemented using sequential logic circuits. Generally, an FSM is faster and uses less power than, for example, providing such functionality in an MCU.

In various embodiments, the calibration module 106 determines a per axis (e.g., x, y, z) average offset between the low-g sensor core 122 and the high-g sensor core 124 which is used to for initial offset compensation (e.g., when there is not enough data to determining a running average offset value or there is not a previously saved running average offset value to use). In various embodiments, the calibration module 106 determines such an initial offset value upon startup of the device. After the device has been operating for a while, there should be enough data to determine a running average offset value or a previously saved running average offset value to use. In various embodiments, upon startup of the device the calibration module 106 captures a predetermined number of data points (e.g., 50) for each axis of each sensor core, calculates an average of the data points for each axis from the low-g sensor core 122, calculates an average of the data points for each axis from the high-g sensor core 124, and subtracts the average of the data points for each axis from the low-g sensor core 122 from the average of the data points for each axis from the high-g sensor core 124 to obtain an initial offset value for each axis. In various embodiments, when offset compensation is to be performed (described below), these initial offset values for each respective axis are subtracted from acceleration data from the high-g sensor core 124.

In various embodiments, the FSM 126 reads the output data of the low-g sensor core 122 and the high-g sensor core 124 (depending on which sensor is active (typically the low-g sensor core is active by default) and generates one of the following interrupts: interrupt 1 when the absolute value of the acceleration on any axis of the low-g sensor exceeds a predetermined threshold α (i.e., the acceleration on any axis of the low-g sensor is above α or below the negative of α (in the case of negative acceleration)); interrupt 2 when the absolute value of the acceleration on any axis of the low-g sensor falls below the threshold α (i.e., the acceleration on any axis of the low-g sensor is between α and the negative of α); interrupt 3 when the absolute value of the acceleration on any axis of the high-g sensor falls below the predetermined threshold β (i.e., the acceleration on any axis of the high-g sensor is between β and the negative of β); or interrupt 4 when the absolute value of the acceleration on any axis of the high-g sensor exceeds a predetermined threshold β (i.e., the acceleration on any axis of the high-g sensor is above β or below the negative of β (in the case of negative acceleration)).

Generally, in various embodiments the threshold α should be set somewhat lower than the limit of the low-g sensor so that there is an overlap in which both the low-g sensor and the high-g sensor operate and the predetermined threshold β is set to the limit of the low-g sensor. In one example, α is set to 13 g and β is set to 16 g, however any suitable thresholds may be used.

In various embodiments, the interrupt handler module 110 receives the interrupt from the FSM 126 and identifies which one (or both) of the high-g and low-g sensor cores should be activated as follows: when interrupt 2 is received only the low-g sensor core 122 is selected; when interrupt 4 is received only the high-g sensor core 124 is selected; and when interrupt 1 or interrupt 3 is received both sensor cores are selected.

In various embodiments, the interrupt handler module 110 sends instructions to the sensor selection module 108 as to which sensor core(s) to activate and the sensor selection module 108 then turns on or off the requested sensor core(s) (such as via I2C/SPI/I3C bus register reads/writes). In this regard, power consumption is reduced since only the needed sensor(s) is/are active.

In various embodiments, when interrupt 2 is received and only the low-g sensor core is selected, the low-g data is passed directly to the user application 118 without any processing. In various embodiments, when interrupt 4 is received and only the high-g sensor only is selected, the high-g data undergoes offset compensation (described below) and (optionally) noise compensation (described below) and the compensated high-g data passed to the user application 118. In various embodiments, when both sensors are selected in response to interrupt 1 or interrupt 3 (this is termed a transition period, i.e., a transition between use of only the low-g and use of only the high-g sensor), the high-g data undergoes offset compensation (described below) and (optionally) noise compensation (described below), the compensated high-g data is fused with the low-g data (described below), and the fused data is then passed to the user application 118.

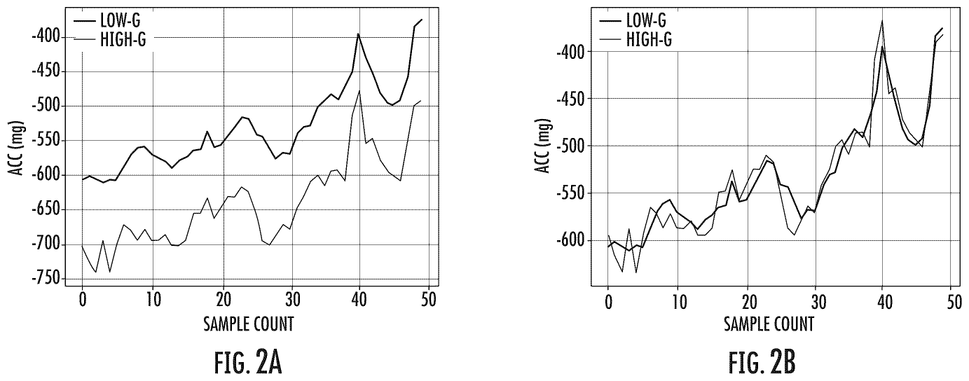

In various embodiments, in the case of interrupt 4 when only the high-g sensor is selected or interrupts 1 or 3 when both sensors are selected, the offset handling module 112 applies an offset to the high-g data to compensate for the offset between the output of the high-g sensor and the output of the low-g sensor (such as is illustrated in FIG. 2A). In various embodiments, in the case of interrupt 4 when only the high-g sensor is selected, the offset value used is either an initial offset value determined during calibration (described above) or a previously saved offset value. In various embodiments, the initial offset value or the previously saved offset value is subtracted from each high-g data point to obtain the offset compensated high-g data. In various embodiments, this offset compensated high-g data is then passed on to the noise handling module 114 and/or output to the user application 118.

In various embodiments, in the case of interrupts 1 or 3 when both sensors are selected, the initial offset value is initially used if there is not a sufficient number of high-g and low-g data points to calculate a running average offset value. However, due to different temporal evolution of the offsets of the two cores, the initial offset will not be valid after some time. When a sufficient number of high-g and low-g data points (e.g., 50) are available, a running average offset value is used for time-varying offset compensation (i.e., the offset value changes over time and therefore provides a more accurate offset compensation). In various embodiments, a running average offset value is calculated by subtracting a running average of the low-g data (e.g., over the last 50 data points) from a running average of the high-g data (e.g., over the last 50 data points). In various embodiments, the running average offset value is subtracted from each high-g data point to obtain the time-varying offset compensated high-g data. In various embodiments, this time-varying offset compensated high-g data is then passed on to the noise handling module 114 or optionally directly to the discontinuity removal module 116. In various embodiments, the most recent running average offset value is stored in memory for offset compensation when only the high-g cores is active.

In FIG. 2A, the time-varying offset between the high-g data (thinner line) and the low-g data (thicker line) is readily seen, and in FIG. 2B the high-g data (thinner line) has been offset compensated such that the high-g data is very close to the low-g data (the remaining differences are due mainly to the higher noise and lower resolution of the high-g sensor).

In various embodiments, the noise handling module 114 uses using any suitable mechanism or method (such as a median filter) to remove the noise from the high-g data (the low-g data is relatively low noise and does not typically require noise removal). If noise removal is implemented, in various embodiments, the noise handling module 114 passes the offset compensated, noise removed high-g data either to the user application 118 (in the case of interrupt 4) or to the discontinuity removal module 116 (in the case of interrupt 1 or 3).

In various embodiments, the discontinuity removal module 116 fuses the low-g data and the time-varying offset compensated (and optionally noise removed) high-g data in the transition period (i.e., between the α threshold (e.g., 13 g/−13 g) and the β threshold (e.g., 16 g/−16 g)). The discontinuity only needs to be removed in the transition period.

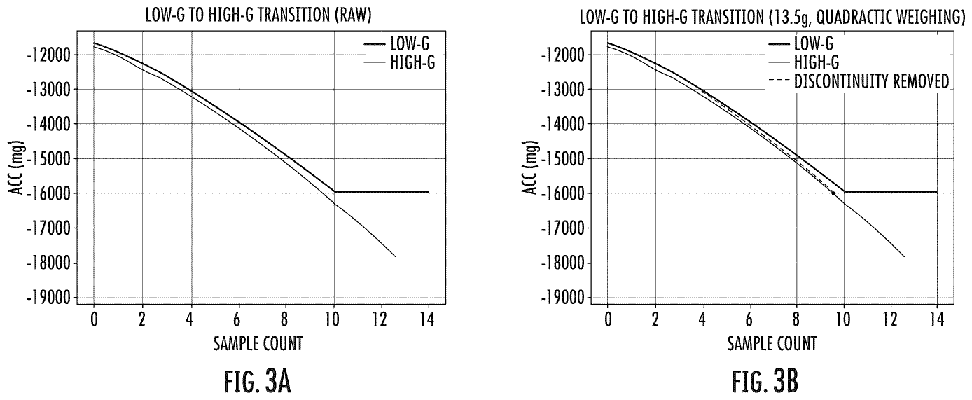

In various embodiments, fusing the low-g data and the high-g data comprises blending, from the α threshold to the β threshold (or vice versa), the low-g data and the high-g data such that the blended data coincides with the low-g data at the α threshold and coincides with the high-g data at the β threshold. This can be seen in FIG. 3B in which a dashed line runs from the low-g data at the α threshold (−13 g in this example) to the high-g data at the β threshold (−16 g in this example). In various embodiments, any suitable technique (such as quadratic weighting) may be used to blend the high-g data and the low-g data in the transition period. By fusing the low-g data and the high-g data in the transition period, embodiments of the present disclosure are able to provide a smooth transition, without a discontinuity, from the low-g data to the high-g data or from the high-g data to the low-g data.

In the example of FIG. 3B, above −13 g, the low-g data (thicker line) is used; below −16 g, the high-g data (thinner line) is used; and between −13 g and −16 g (i.e., the transition period), the fused data (dashed line) is used.

Microcontroller 102 may be embodied in a number of different ways. In various embodiments, the use of the terms “processor,” “processing circuity,” “controller,” or “control circuitry” should be understood to include a single core processor, a multi-core processor, multiple processors internal to the device 100. In some example embodiments, MCU 102 may include one or more processing devices configured to perform independently. Alternatively, or additionally, MCU 102 may include one or more processor(s) configured in tandem via a bus to enable independent execution of operations, instructions, pipelining, and/or multithreading.

In an example embodiment, the MCU 102 may be configured to execute instructions stored in a memory circuitry (not illustrated) accessible to the processor. Alternatively, or additionally, the MCU 102 may be configured to execute hard-coded functionality. As such, whether configured by hardware or software methods, or by a combination thereof, MCU 102 may represent an entity (e.g., physically embodied in circuitry) capable of performing operations according to embodiments of the present disclosure while configured accordingly. Alternatively, or additionally, MCU 102 may be embodied as an executor of software instructions, and the instructions may specifically configure the MCU 102 to perform the various algorithms embodied in one or more operations described herein when such instructions are executed. In some embodiments, the MCU 102 includes hardware, software, firmware, and/or a combination thereof that performs one or more operations described herein.

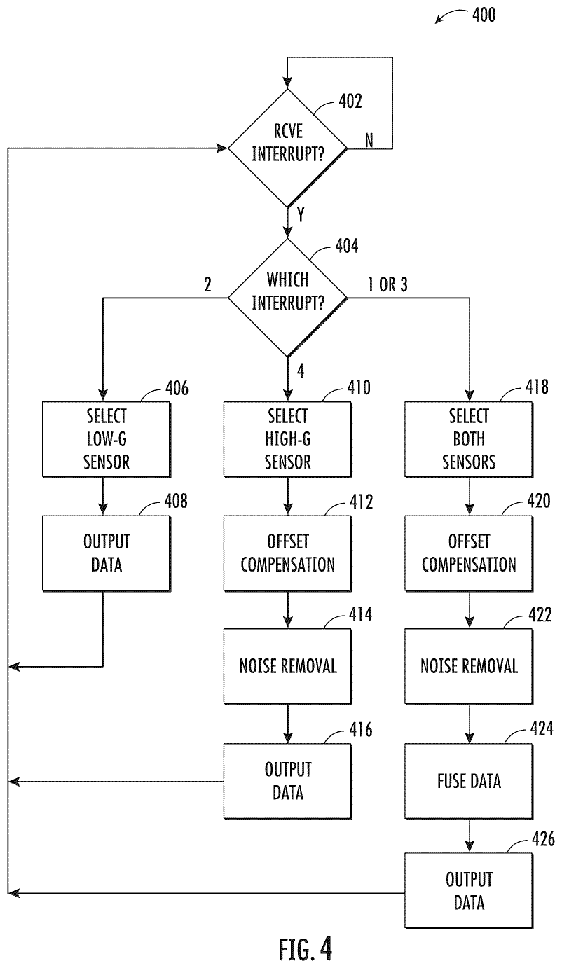

Reference will now be made to FIG. 4 which provides flowcharts illustrating example steps, processes, procedures, and/or operations in accordance with various embodiments of the present disclosure. Various methods described herein, including, for example, example methods as shown in FIG. 4, may provide various technical benefits and improvements. It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIG. 4 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Referring now to FIG. 4, an example flow diagram illustrating an example method 400 for fusing data between two accelerometers having different operating ranges in accordance with some embodiments of the present disclosure is illustrated. In some embodiments, the example method 400 may be implemented by an example MCU of an example mobile device described herein, including, but not limited to, the example MCU 102 of the example device 100 described above in connection with FIG. 1.

The example method 400 shown in FIG. 4 starts at step/operation 402. At step/operation 402, a processor (such as, but not limited to, the interrupt handler module 110 of the MCU 102 of the device 100 described above in connection with FIG. 1) determines if an interrupt has been received (such as, but not limited to, from the FSM 126 of the device 100 described above in connection with FIG. 1).

If it is determined at step/operation 402 that an interrupt has not been received, the example method 400 continues to wait for an interrupt. If it is determined at step/operation 402 that an interrupt has been received, the example method 400 proceeds to step/operation 404.

At step/operation 404, a processor (such as, but not limited to, the interrupt handler module 110 of the MCU 102 of the device 100 described above in connection with FIG. 1) determines which interrupt has been received. For example, the interrupts may comprise interrupt 1, interrupt 2, interrupt 3, and interrupt 4 as described above. If it is determined at step/operation 404 that interrupt 2 has been received, the method 400 proceeds to step/operation 406.

At step/operation 406, a processor (such as, but not limited to, the sensor selection module 108 of the MCU 102 of the device 100 described above in connection with FIG. 1) selects the low-g sensor and communicates this selection to an accelerometer module (such as, but not limited to, from the accelerometer module 120 of the device 100 described above in connection with FIG. 1) such that the accelerometer handling module 104 receives data from the low-g sensor core.

At step/operation 408, a processor (such as, but not limited to, the MCU 102 of the device 100 described above in connection with FIG. 1) outputs the low-g data (such as, but not limited to, to the user application 118 of the device 100 described above in connection with FIG. 1). The low-g data continues to be output until another interrupt is received or the device is turned off.

If it is determined at step/operation 404 that interrupt 4 has been received, the method 400 proceeds to step/operation 410. At step/operation 410, a processor (such as, but not limited to, the sensor selection module 108 of the MCU 102 of the device 100 described above in connection with FIG. 1) selects the high-g sensor and communicates this selection to an accelerometer module (such as, but not limited to, from the accelerometer module 120 of the device 100 described above in connection with FIG. 1) such that the accelerometer handling module 104 receives data from the high-g sensor core.

At step/operation 412, a processor (such as, but not limited to, the offset handling module 112 of the MCU 102 of the device 100 described above in connection with FIG. 1) performs offset compensation on the high-g data. As described above, the offset compensation may be performed using an initial offset value or a most recent running average offset stored in memory.

At step/operation 414, a processor (such as, but not limited to, the noise handling module 114 of the MCU 102 of the device 100 described above in connection with FIG. 1) removes at least some of the noise from the offset compensated high-g data using any suitable noise removal method or mechanism.

At step/operation 416, a processor (such as, but not limited to, the MCU 102 of the device 100 described above in connection with FIG. 1) outputs the offset compensated, noise removed high-g data (such as, but not limited to, to the user application 118 of the device 100 described above in connection with FIG. 1). The offset compensated, noise removed high-g data continues to be output until another interrupt is received or the device is turned off.

If it is determined at step/operation 404 that interrupt 1 or 3 has been received, the method 400 proceeds to step/operation 418. At step/operation 418, a processor (such as, but not limited to, the sensor selection module 108 of the MCU 102 of the device 100 described above in connection with FIG. 1) selects both the low-g and the high-g sensor and communicates this selection to an accelerometer module (such as, but not limited to, from the accelerometer module 120 of the device 100 described above in connection with FIG. 1) such that the accelerometer handling module 104 receives data from the low-g and high-g sensor cores.

At step/operation 420, a processor (such as, but not limited to, the offset handling module 112 of the MCU 102 of the device 100 described above in connection with FIG. 1) performs time-varying offset compensation on the high-g data. As described above, the time-varying offset compensation may be performed using a running average offset value.

At step/operation 422, a processor (such as, but not limited to, the noise handling module 114 of the MCU 102 of the device 100 described above in connection with FIG. 1) removes at least some of the noise from the time-varying offset compensated high-g data using any suitable noise removal method or mechanism.

At step/operation 424, a processor (such as, but not limited to, the discontinuity removal module 116 of the MCU 102 of the device 100 described above in connection with FIG. 1) fuses the high-g data and the low-g data. As described above, any suitable technique (such as quadratic weighting) may be used to blend the high-g data and the low-g data in this transition period.

At step/operation 426, a processor (such as, but not limited to, the MCU 102 of the device 100 described above in connection with FIG. 1) outputs the fused data (such as, but not limited to, to the user application 118 of the device 100 described above in connection with FIG. 1). The fused data continues to be output until another interrupt is received or the device is turned off.

In various embodiments, the example method 400 run continuously while the device is turned on.

### Conclusion

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of device which uses two accelerometers having two different operating ranges, including but not limited to mobile phones, smart watches, and sports equipment (e.g., for bowling, golf, etc.).

Within the appended claims, unless the specific term “means for” or “step for” is used within a given claim, it is not intended that the claim be interpreted under 35 U.S.C. 112, paragraph 6.

What is claimed is:

1. A method for fusing data between a first accelerometer having a first operating range and a second accelerometer having a second operating range greater than the first operating range, the method comprising:
determining (i) if an acceleration of any axis of the first accelerometer is between a first threshold and a negative of the first threshold or (ii) if an acceleration of any axis of the second accelerometer is greater than a second threshold or less than a negative of the second threshold, the second threshold being greater than the first threshold, or (iii) if an acceleration of any axis of the first accelerometer is greater than the first threshold or less than the negative of the first threshold or if an acceleration of any axis of the second accelerometer is between the second threshold and the negative of the second threshold;
when the acceleration of any axis of the first accelerometer is between the first threshold and the negative of the first threshold, (i) receiving data from only the first accelerometer and (ii) outputting the data received from the first accelerometer without further processing;
when the acceleration of any axis of the second accelerometer is greater than the second threshold or less than the negative of the second threshold, (i) receiving data from only the second accelerometer, (ii) performing offset compensation on the data received from the second accelerometer to compensate for an offset between data from the second accelerometer and data from the first accelerometer, and (iii) outputting the offset compensated data from the second accelerometer; and
when the acceleration of any axis of the first accelerometer is greater than the first threshold or less than the negative of the first threshold or the acceleration of any axis of the second accelerometer is between the second threshold and the negative of the second threshold, (i) receiving data from both the first accelerometer and the second accelerometer; (ii) performing time-varying offset compensation on the data received from the second accelerometer to compensate for a time-varying offset between data from the second accelerometer and data from the first accelerometer, (iii) fusing the data from the first accelerometer and the time-varying offset compensated data from the second accelerometer between the first threshold and the second threshold, and (iii) outputting the fused data.

2. The method of claim 1, wherein determining if an acceleration of any axis of the first accelerometer is between a first threshold and a negative of the first threshold comprises receiving a second interrupt signal indicating that the acceleration of any axis of the first accelerometer has gone from above the first threshold to below the first threshold or has gone from below the negative of the first threshold to above the negative of the first threshold:
wherein determining if an acceleration of any axis of the second accelerometer is greater than a second threshold or less than a negative of the second threshold comprises receiving a fourth interrupt signal indicating that the acceleration of any axis of the second accelerometer has gone from below the second threshold to above the second threshold or has gone from above the negative of the second threshold to below the negative of the second threshold;
wherein determining if an acceleration of any axis of the first accelerometer is greater than the first threshold or less than the negative of the first threshold comprises receiving a first interrupt indicating that the acceleration of any axis of the first accelerometer has gone from below the first threshold to above the first threshold or has gone from above the negative of the first threshold to below the negative of the first threshold; and
wherein determining if an acceleration of any axis of the second accelerometer is between the second threshold and the negative of the second threshold comprises receiving a third interrupt indicating that the acceleration of any axis of the second accelerometer has gone from above the second threshold to below the second threshold or has gone from below the negative of the second threshold to above the negative of the second threshold.

3. The method of claim 1, further comprising:
activating the first accelerometer when the second interrupt signal is received;
activating the second accelerometer when the fourth interrupt signal is received; and
activating the first accelerometer and the second accelerometer when the first interrupt signal is received or when the third interrupt signal is received.

4. The method of claim 1, wherein performing offset compensation on the data received from the second accelerometer comprises subtracting a most recent offset value from each point of data received from the second accelerometer.

5. The method of claim 4, wherein the most recent offset value comprises a difference between an average of data from the second accelerometer and an average of data from the first accelerometer during a startup test.

6. The method of claim 4, wherein the most recent offset value comprises a most recently calculated difference between a running average of data from the second accelerometer and a running average of data from the first accelerometer.

7. The method of claim 1, wherein performing time-varying offset compensation on the data received from the second accelerometer comprises subtracting from each point of data received from the second accelerometer a difference between a running average of data from the second accelerometer and a running average of data from the first accelerometer.

8. The method of claim 1, wherein fusing the data from the first accelerometer and the time-varying offset compensated data from the second accelerometer comprises blending, from the first threshold to the second threshold, the data from the first accelerometer and the data from the second accelerometers such that the blended data coincides with the data from the first accelerometer at the first threshold and coincides with the data from the second accelerometer at the second threshold.

9. The method of claim 1, wherein, when the acceleration of any axis of the second accelerometer is greater than the second threshold or less than the negative of the second threshold, the method further comprises:
after performing offset compensation on the data received from the second accelerometer and before outputting the offset compensated data from the second accelerometer, removing noise from the compensated data.

10. The method of claim 1, wherein, when the acceleration of any axis of the first accelerometer is greater than the first threshold or less than the negative of the first threshold or the acceleration of any axis of the second accelerometer is between the second threshold and the negative of the second threshold, the method further comprises:
after performing time-varying offset compensation on the data received from the second accelerometer and before fusing the data from the first accelerometer and the time-varying offset compensated data, removing noise from the time-varying offset compensated data.

11. The method of claim 1, wherein the second threshold is an upper operating limit of the first accelerometer.

12. The method of claim 11, wherein the first operating range of the first accelerometer is =/−16 g the second operating range of the second accelerometer is =/−256 g.

13. The method of claim 12, wherein the first threshold is 13 g and the second threshold is 16 g.

14. A semiconductor system-in-package device for generating interrupt signals related to output data from two accelerometers having different operating ranges, the device comprising:
a first accelerometer having a first operating range;
a second accelerometer having a second operating range greater than the first operating range; and
circuitry for implementing a finite state machine configured to:
monitor output data from the first accelerometer and output data from the second accelerometer; and
output one of a plurality of interrupt signals based on the output data from the first accelerometer and/or the output data from the second accelerometer.

15. The device of claim 14, wherein the circuitry for implementing a finite state machine is further configured to:
determine if an acceleration of any axis of the first accelerometer has gone from above a first threshold to below the first threshold or has gone from below a negative of the first threshold to above the negative of the first threshold:
determine if an acceleration of any axis of the second accelerometer has gone from below a second threshold to above the second threshold or has gone from above a negative of the second threshold to below the negative of the second threshold, the second threshold being greater than the first threshold;
determine if an acceleration of any axis of the first accelerometer has gone from below the first threshold to above the first threshold or has gone from above the negative of the first threshold to below the negative of the first threshold;
determine if an acceleration of any axis of the second accelerometer has gone from above the second threshold to below the second threshold or has gone from below the negative of the second threshold to above the negative of the second threshold;
if an acceleration of any axis of the first accelerometer has gone from above the first threshold to below the first threshold or has gone from below the negative of the first threshold to above the negative of the first threshold, output a second interrupt signal;
if an acceleration of any axis of the second accelerometer has gone from below the second threshold to above the second threshold or has gone from above the negative of the second threshold to below the negative of the second threshold, output a fourth interrupt signal;
if an acceleration of any axis of the first accelerometer has gone from below the first threshold to above the first threshold or has gone from above the negative of the first threshold to below the negative of the first threshold, output a first interrupt signal; and
if an acceleration of any axis of the second accelerometer has gone from above the second threshold to below the second threshold or has gone from below the negative of the second threshold to above the negative of the second threshold, output a third interrupt signal.

16. The device of claim 15, wherein the second threshold is an upper operating limit of the first accelerometer.

17. The device of claim 16, wherein the first operating range of the first accelerometer is =/−16 g the second operating range of the second accelerometer is =/−256 g;
wherein the first threshold is 13 g; and
wherein the second threshold is 16 g.

18. A method for generating interrupt signals related to output data from a first accelerometer having a first operating range and output data from a second accelerometer having a second operating range greater than the first operating range, the method comprising:
monitoring output data from the first accelerometer and output data from the second accelerometer;
determining if an acceleration of any axis of the first accelerometer has gone from above a first threshold to below the first threshold or has gone from below a negative of the first threshold to above the negative of the first threshold:
determining if an acceleration of any axis of the second accelerometer has gone from below a second threshold to above the second threshold or has gone from above a negative of the second threshold to below the negative of the second threshold, the second threshold being greater than the first threshold;
determining if an acceleration of any axis of the first accelerometer has gone from below the first threshold to above the first threshold or has gone from above the negative of the first threshold to below the negative of the first threshold;
determining if an acceleration of any axis of the second accelerometer has gone from above the second threshold to below the second threshold or has gone from below the negative of the second threshold to above the negative of the second threshold;
if an acceleration of any axis of the first accelerometer has gone from above the first threshold to below the first threshold or has gone from below the negative of the first threshold to above the negative of the first threshold, outputting a second interrupt signal;
if an acceleration of any axis of the second accelerometer has gone from below the second threshold to above the second threshold or has gone from above the negative of the second threshold to below the negative of the second threshold, outputting a fourth interrupt signal;
if an acceleration of any axis of the first accelerometer has gone from below the first threshold to above the first threshold or has gone from above the negative of the first threshold to below the negative of the first threshold, outputting a first interrupt signal; and
if an acceleration of any axis of the second accelerometer has gone from above the second threshold to below the second threshold or has gone from below the negative of the second threshold to above the negative of the second threshold, outputting a third interrupt signal.

19. The method of claim 18, wherein the second threshold is an upper operating limit of the first accelerometer.

20. The method of claim 19, wherein the first operating range of the first accelerometer is =/−16 g the second operating range of the second accelerometer is =/−256 g;
wherein the first threshold is 13 g; and
wherein the second threshold is 16 g.
